(19) United States
(12) Patent Application Publication
(10) Pub. No.: US 2026/0346553 A1
(43) Pub. Date: Nov. 5, 2026

(54) LAYUP OF PRE-MANUFACTURED ELEMENTS IN A WIND TURBINE BLADE PART MOLD

(71) Applicant: LM WIND POWER A/S, Kolding (DK)

(72) Inventors: Thomas NYTOFT, Kolding (DK); Henrik BARSLEV, Cherbourg-en-Cotentin (FR)

(21) Appl. No.: 19/104,998

(22) PCT Filed: Aug. 21, 2023
(86) PCT No.: PCT/EP2023/072919

§ 371 Date: Feb. 19, 2025

(30) Foreign Application Priority Data
Aug. 22, 2022 (GB) 2212181.8

(51) Int. Cl. B29C 70/38; B25J 15/06; B29C 70/54; B29L 31/08

(52) U.S. Cl. CPC B29C 70/38; B25J 15/0616; B29C 70/541; B29L 2031/085

(57) ABSTRACT

The present invention provides a system for laying up a first plurality of pre-manufactured elements in a mold for a fibre-reinforced wind turbine blade part. The system comprises: a mold for forming the fibre-reinforced wind turbine blade part; a platform for carrying the first plurality of elements, the platform being moveable above and along at least a part of the mold, the platform being moveable to a loading position at which the first plurality of elements can be loaded to the platform; pick-and-place means for picking up each of the elements of the first plurality of elements when carried on the platform and while the platform is located above the mold, and placing the elements at corresponding positions in the mold. A corresponding method and a layup tool are also provided.

### FIELD OF THE INVENTION

The invention relates to a method, a system, and a layup tool for manufacturing a composite wind turbine blade shell part comprising a plurality of pre-manufactured elements such as wind turbine blade core panels.

### BACKGROUND OF THE INVENTION

Wind power provides a clean and environmentally friendly source of energy. Wind turbines usually comprise a tower, generator, gearbox, nacelle, and one or more rotor blades. The wind turbine blades capture kinetic energy of wind using known airfoil principles. Wind turbine blades are usually manufactured by forming two shell parts or shell halves from layers or plies of woven fabric or fibre and resin.

Wind turbine blades continue to increase in size, both in length and in width, and thus more material is needed when manufacturing a wind turbine blade shell part in a mold. This is complex in terms of organizing the materials that go into the mold and bringing those materials as well as consumables to their point of use during manufacturing. There is a tendency that personnel spend significantly more time in the mold when the blade size increases because more material needs to be brought into the mold, which increases the amount of traffic on certain parts of the mold and thereby on material already meticulously arranged in the mold. This prolongs the manufacturing time, as defects in already laid-up material must be corrected. Furthermore, the time needed for transporting materials also increases and requires personnel that could advantageously perform more productive tasks than transporting materials.

Accordingly, there is a need to reduce the amount of personnel traffic in the mold during manufacturing of wind turbine blade shell parts, a problem that is exacerbated as the size of wind turbine blades increases.

### SUMMARY

The above issues are mitigated by embodiments disclosed herein.

In a first aspect, the invention provides a system for laying up a first plurality of pre-manufactured elements in a mold for a fibre-reinforced wind turbine blade part, such as a wind turbine blade shell part. The system comprises:
a mold for forming the fibre-reinforced wind turbine blade part,
a platform for carrying the first plurality of elements, the platform being moveable above and along at least a part of the mold, the platform being moveable to a loading position at which the first plurality of elements can be loaded to the platform,
pick-and-place means for picking up each of the elements of the first plurality of elements when carried on the platform and while the platform is located above the mold, and placing the elements at corresponding positions in the mold.

Systems in accordance with the first aspect of the invention eliminate or at least reduce the need for personnel to walk in a mold to place pre-manufactured elements in the mold for a wind turbine blade part, such as a wind turbine blade shell part. This avoids personnel contact with material already placed in the mold, which is easily disturbed if walked on. If the material is disturbed, it will need to be rearranged in the mold, which takes time. Another advantage of the systems is that a plurality of elements is readily available where they are to be placed, which increases the layup speed. For some types of elements, such as core panels, the distance between adjacent elements must be at most 2 mm, which takes time to achieve. The present invention compensates for this time-consuming process in two ways, namely by making it easier to place the panels and by making panels available at the different points of use more quickly.

In some embodiments, the system further comprises a gantry moveable along at least a part of the mold, the platform and/or the pick-and-place means being attached to or attachable to the gantry. Gantries are already used at many wind turbine blade part manufacturing sites and can accommodate different tools. However, conventionally, the tools are deposition tools that deliver materials such as fibre mats and adhesive. Attaching the platform and preferably also the pick-and-place means to the gantry takes advantage of the presence of the gantry, allowing pre-manufactured elements to be transported via the gantry by use of the platform and the pick-and-place means. Existing gantries are already moveable along molds and have a high carrying capacity, making them ideal for carrying the platform and pick-and-place means of the present invention.

In some embodiments, the pick-and-place means and the platform both form parts of a layup tool attachable to and detachable from the gantry. Such a tool, being attachable to the gantry, makes it easy to configure the gantry with the platform and the pick-and-place means.

In some embodiments, the pick-and-place means is adapted to pick up and place core elements for a wind turbine blade shell in the mold, such as core panels for a wind turbine blade shell. Such core panels are typically placed on top of fibre material already laid up in the mold. This means that the placement of core panels is a process that takes place when the mold contains fibre material. As described above, such material is easily disturbed if walked upon. The present invention is particularly well suited for placing core panels, the core panels being placed on fibre material already in the mold. Similarly, the invention is well suited for placing kits of sectional preforms, for instance sections made of glass layers. In addition, the plurality of core panels used in a wind turbine blade part are similar to one another in shape and size, which makes them suitable for being relatively easily arranged, such as by stacking, on the platform or in a container on the platform, such as a pallet or a cardboard box or a trolley or other container. Thus, systems in accordance with the invention can significantly reduce the time needed to transport elements to the point of use in the mold. This leads to higher turn-around times, i.e. a reduced cycle time associated with placing the components.

Mechanical pick-and-place means reduces the need for personnel to handle elements. This leads to less damage to the elements and makes it easier to place elements in parts of the mold that are not easily accessible for personnel.

In some embodiments, the pick-and-place means is manually operated. In other embodiments, the pick-and-place means for picking up and placing the first plurality of elements in the mold comprises a robot controllable by a robot controller, and the robot comprises a gripper end effector for picking up each of the elements of the plurality of elements. It is implied that the robot has at least the number of degrees of freedom necessary to allow it to pick up elements from the platform and place them correctly in the mold. If different elements need to be placed at different angles, which is typically necessary since the mold surface is curved, the robot needs to be able to place elements at corresponding different angles. This is most easily achieved for instance by using a gripper with a joint. Other ways of controlling the angle of elements may be used, but they tend to be more complicated and to require more space.

The robot may be manually operated, meaning that an operator gives input in order to control the robot's motion. Alternatively, the robot is partly automated, for instance by allowing an operator to use a joystick and have the robot controller control the degrees of freedom to effect the desired motion.

In some embodiments, the system further comprises:
means for identifying a first element of the first plurality of elements and a second element of the first plurality of elements, the second element being distinguishable from the first element,
a digital controller configured to control the pick-and-place means to perform the steps of:
   i. picking up the first element from the platform, identifying the first element, and placing the first element at a first location associated with the first element; and
   ii. picking up the second element from the platform, identifying the second element, and placing the second element at a second location associated with the second element, wherein the second location is different from the first location.

This can make the robot fully automated so as to be able to pick up and place at least two elements in corresponding positions without interference by personnel. In some embodiments, the automation further includes control of the gantry, whereby the pick-and-place means can also be moved along the mold to reach a particular position, when necessary. If necessary, placement positions for the elements are stored in a digital storage and are retrieved and used by the system to place a particular element correctly.

In some embodiments, identifying the first element and the second element comprises identifying the first element and the second element based on one or more of: a shape of the elements; a dimension of the elements; a colour of the elements; a weight of the elements; an electronic tag on or in the elements. Corresponding means is then included in the system.

In some embodiments, the means for identifying the first element and the second element comprises imaging means for recording an image of the first element and an image of the second element, and the digital controller is configured to identify the first element and the second element based on the images. The images might for instance be analysed to determine the first element and the second element based on one or more of: letters and/or number on the elements; barcodes on the elements. It is common to label different elements since many elements are unique and must be placed in corresponding unique positions. The system according to the embodiment provides automation based on visual markings.

In some embodiments, the pick-and-place means uses vacuum means to pick up each of the elements of the first plurality of elements. Vacuum gripping provides a gentle way of gripping elements and is useful when the elements are made of a material that allows a sufficient vacuum to be established at the interface between the vacuum means and each of the elements.

In some embodiments, the pick-and-place means comprises a vacuum lifter with one or more suction elements for contacting and holding each of the elements of the first plurality of elements.

In some embodiments, the pick-and-place means comprises a vacuum spider for picking up each of the plurality of elements from the platform. Vacuum spiders are flexible and allow controlled gripping of elements having a curved surface.

Bringing the vacuum means into correct contact with elements can be done by an operator, or the system can be configured to change a pose of the gripper automatically, for instance based on an imaging system, such as the imaging means described above, or using contact-sensing or distance-sensing means.

In some embodiments, the loading position of the platform is in a vicinity of a root end of the mold, preferably a position where the platform is not positioned over the mold. This reduces the risk of dropping elements or containers onto the mold, should an accident occur during loading. In some embodiments, the platform is vertically displaceable at least at the loading position, optionally to a height at which the platform rests on the ground. This makes loading elements onto the platform safer.

A second aspect of the invention provides a method for laying up a first plurality of pre-manufactured elements in a mold for a fibre-reinforced wind turbine blade part, such as a wind turbine blade shell part. The method comprises:
placing the first plurality of elements on a platform at a loading position, the platform being moveable above and along at least a part of the mold,
moving the platform to a first platform position along the mold and picking up, using the pick-and-place means, a first element of the first plurality of elements and placing the first element at a first element position in the mold,
picking up, using the pick-and-place means, a second element of the first plurality of elements and placing the second element at a second element position different from the first element position.

In some embodiments, the method comprises moving the platform after moving the platform to the first platform position and before placing the second element. In some embodiments, the platform is moved simultaneously with the pick-and-place means picking up the first or the second element. This reduces the time it takes to place the plurality of elements.

In some embodiments, the pick-and-place means comprises a robot with a gripper end effector for performing the steps of picking up and placing the first element and the second element in the mold, and the pick-and-place means and the platform are parts of a layup tool that is releasably attached to a gantry moveable along the mold. In some embodiments, the pick-and-place means comprises a jib crane system.

In some embodiments, the pick-and-place means includes a cantilever beam or cantilever jib.

In some embodiments, the first element and the second element are picked up and placed without loading one or more additional elements onto the platform after picking up and placing the first element and before picking up and placing the second element. This saves even more time by avoiding having to move the pick-and-place means to a loading position each time an element to be placed is needed.

In some embodiments, the method further comprises:
placing a second plurality of elements in the mold, wherein the second plurality of elements are elements other than core elements.
forming a mold cavity by placing a vacuum bag over the mold, the mold cavity comprising at least the first plurality of elements,
infusing resin into the mold cavity and curing the resin.

In some embodiments, the method further comprises:
moving the platform to the first platform position or to a second platform position along the mold,
picking up, using the pick-and-place means, a first element of the second plurality of elements and placing the first element of the second plurality of elements at a third element position in the mold,
picking up, using the pick-and-place means, a second element of the second plurality of elements and placing the second element of the second plurality of elements at a fourth element position different from the third element position.

In this embodiment, the pick-and-place means is adapted to be able to handle a second plurality of elements.

In some embodiments, the first plurality of elements is a first plurality of core elements (core panels), such as a first plurality of core panels, for forming one or more core portions of a wind turbine blade part.

The second plurality of elements may for instance be another type of core panels. For instance, the first plurality of elements could be core panels and the second plurality of elements could be sectional preforms making up a kit of sectional preforms.

The resin (such as a polyester, a vinyl-ester, or an epoxy) acts as a matrix material for the elements.

In some embodiments, the pick-and-place means uses vacuum means to pick up each of the elements of the first plurality of elements.

In some embodiments, the pick-and-place means comprises a vacuum lifter with one or more suction elements for picking up and holding each of the elements of the first plurality of elements.

In some embodiments, the pick-and-place means comprises a vacuum spider for picking up each of the plurality of elements from the platform.

In a third aspect, the invention provides a layup tool for laying up a plurality of pre-manufactured elements, the layup tool being attachable to a gantry configured to travel along a mold for forming a wind turbine blade shell part, the layup tool comprising:
a platform,
pick-and-place means for picking up each of the elements of the first plurality of elements when carried on the platform and while the platform is located above the mold and placing the elements at corresponding positions in the mold.

In some embodiments, the layup tool comprises a robot and a robot controller for controlling the robot, the robot comprising a gripper end effector for picking up each of the elements of the plurality of elements from the platform and placing the element in a corresponding position in the mold.

### BRIEF DESCRIPTION OF THE DRAWINGS

The invention is explained in detail below with reference to the embodiments shown in the drawings.

FIG. 1 illustrates a wind turbine.

FIG. 2 Illustrates a Wind Turbine Blade.

FIG. 3 illustrates a mold for a wind turbine blade shell part and a layup gantry.

FIG. 4 illustrates an embodiment of a layup tool for a layup gantry.

FIGS. 5a-5i illustrate a method of laying up wind turbine blade elements in a wind turbine blade shell part mold as seen from a root end of the wind turbine blade shell part.

FIGS. 6a-6d illustrate a top view method of laying up wind turbine blade elements in a wind turbine blade shell part mold.

### DETAILED DESCRIPTION OF SELECTED EMBODIMENTS

Embodiments of the invention will be described in more detail in the following with reference to the accompanying drawings. Like reference numerals may refer to like elements throughout. The drawings show selected ways of implementing the present invention and are not to be construed as limiting the scope of the claims. The features in the drawings are not necessarily drawn to scale.

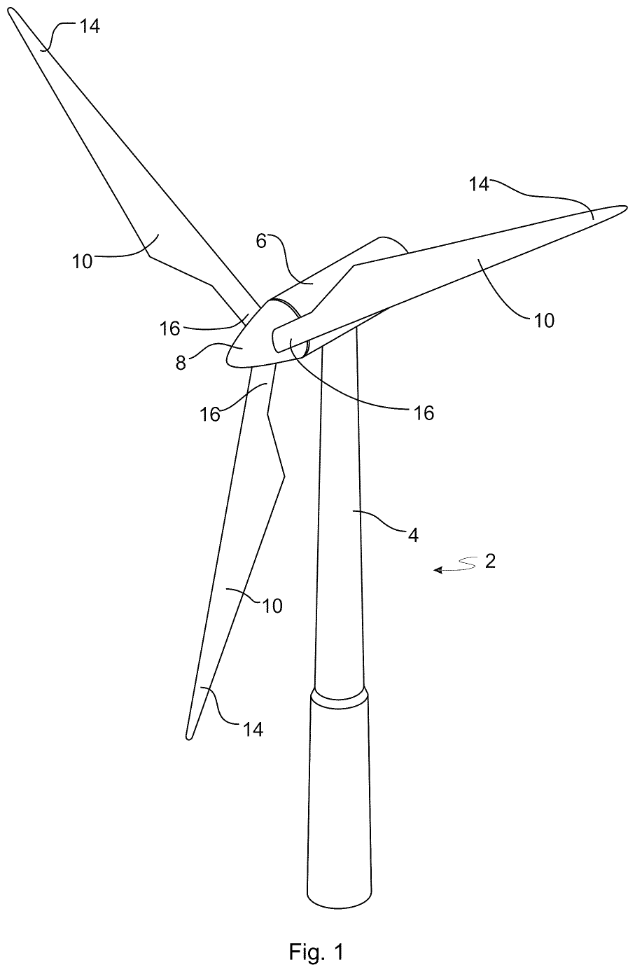

FIG. 1 illustrates a conventional modern upwind wind turbine 2 according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8.

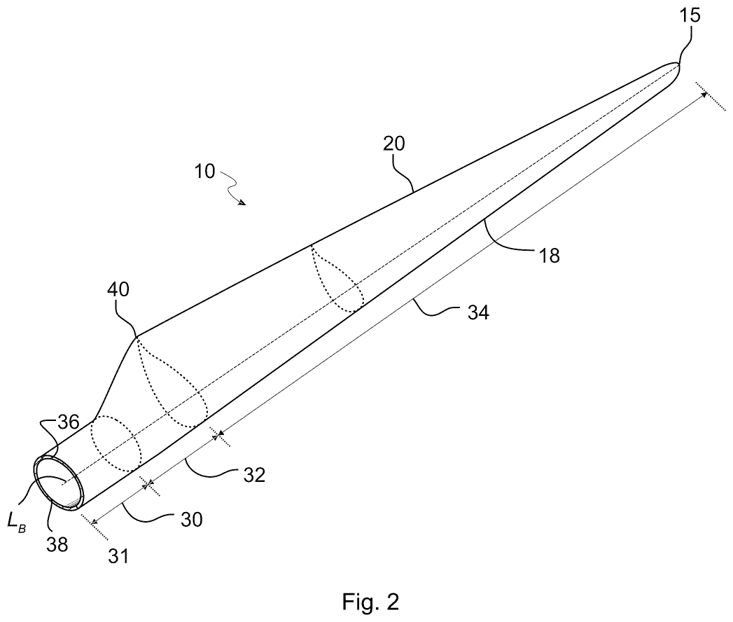

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18. The outermost point of the blade 10 is the tip end 15, located opposite the root end 31 that attaches to the wind turbine hub 8.

The airfoil region 34, also called the profiled region, of the wind turbine blade has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant or may vary along the root region 30. The transition region 32 has a transitional profile gradually changing from the circular or elliptical shape of the root region 30 to the airfoil profile of the airfoil region 34. The chord length of the transition region 32 typically increases with increasing distance from the hub. The airfoil region 34 has an airfoil profile with a chord that extends between the leading edge 18 and the trailing edge 20 of the blade 10. The chord usually decreases with increasing distance from the hub.

A shoulder 40 of the blade 10 is defined as the position where the blade 10 has its largest chord length. The shoulder 40 is typically located at the boundary between the transition region 32 and the airfoil region 34. FIG. 2 also illustrates the longitudinal extent La of the blade 10. La also represents a longitudinal axis of the blade 10.

The blade is typically made from a pressure side shell part 36 and a suction side shell part 38 that are glued to each other along bond lines at the leading edge 18 and the trailing edge 20 of the blade 10. The bond lines are often supplemented by an internal glue flange, as also described above. The present invention addresses how to ensure that the glue joint provided by an internal glue flange provides as much structural strength to the blade as possible.

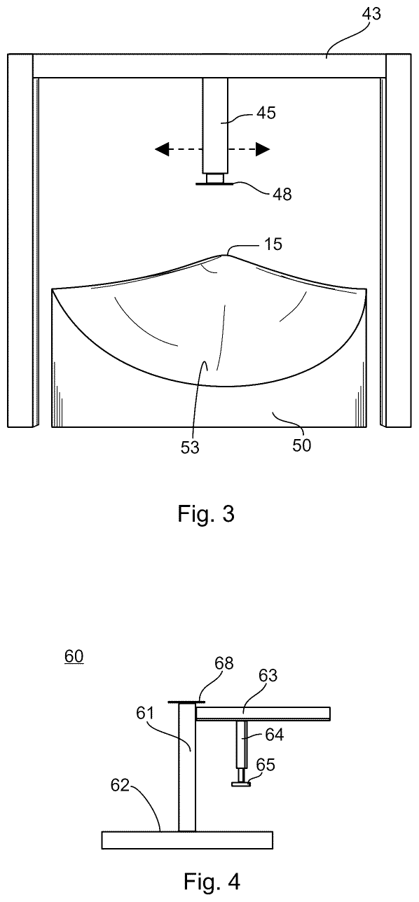

FIG. 3 illustrates a mold for a wind turbine blade shell part, such as a suction side or a pressure side of a wind turbine blade, and a gantry 43 moveable along a longitudinal axis of the mold from a root end (where the gantry 43 in FIG. 3 is currently positioned) to a tip end 15 at the far end of the mold 50.

The gantry comprises a gantry robot arm 45 that can carry various tools for use in manufacturing a wind turbine blade shell part. Such tools can be attached to the gantry robot arm 45 via the gantry robot arm mount 48. The gantry robot arm 45 can travel side-to-side above the mold, as illustrated by the dashed arrow in FIG. 3, thereby allowing tools attached to the gantry robot arm 45 to reach or at least get sufficiently near most or all of the mold 50.

FIG. 4 illustrates a layup tool 60 in accordance with an aspect of the invention. A layup tool mount 68 attachable to the gantry robot arm mount 48 (see FIG. 3) allows the layup tool 60 to be attached to the gantry. The layup tool mount 68 is adapted to the specific gantry robot arm mount 48 of the gantry on which the layup tool 60 is to be mounted.

In an exemplary embodiment, the layup tool 60 is attachable, preferably releasably, to a wind turbine mold gantry 43 and comprises a platform 62 for holding wind turbine blade shell elements, such as core elements for a wind turbine blade shell. The layup tool further comprises pick-and-place means including a gripper end effector 65 attached to displacement means configured to allow the gripper end effector (“gripper”) 65 to be displaced in the three spatial dimensions, whereby an element can be picked up from the platform 62 and positioned freely in the mold within a reach of the pick-and-place means. The gripper 65 can controllably grip and release the elements one by one. The displacement means may for instance comprise a rotatable arm 63 attached to and rotatable about a support structure 61, and lifting means 64 attached to the rotatable arm 63, the lifting means being extendable in a vertical direction and having the gripper 65 connected as an end effector. The lifting means 64 is horizontally displaceable along the rotatable arm 63. In this example, the platform is attached to the support 61, which in this example extends from the layup tool mount 68.

The gripper may for instance be a suction device, which is a non-destructive type of gripper that is suitable for many types of elements, such as core elements, for wind turbine blade shell parts.

Other pick-and-place means may be used.

Depending on the precise embodiment, at least a part of the layup tool is powered, as this can increase operating speed compared to a non-powered tool. Gantries normally have power means for powering conventional tools, since most conventional tools, such as layup tools and other deposition tools, require power to operate. Thus, the layup tool has power connection means for receiving electrical power from a power outlet, such as from a power outlet on the gantry.

Contrary to existing tools, the layup tool 60 in accordance with the invention provides the possibility to deliver a plurality of elements with relative ease and with a speed that significantly exceeds present methods, which are mostly non-mechanized and quite prone to errors, the correction of which wastes valuable time. Furthermore, the layup in accordance with the invention allows transport of a plurality of elements without putting any pressure on the mold and materials already placed in the mold, as the case may be. This reduces the risk of inadvertently displacing elements in the mold.

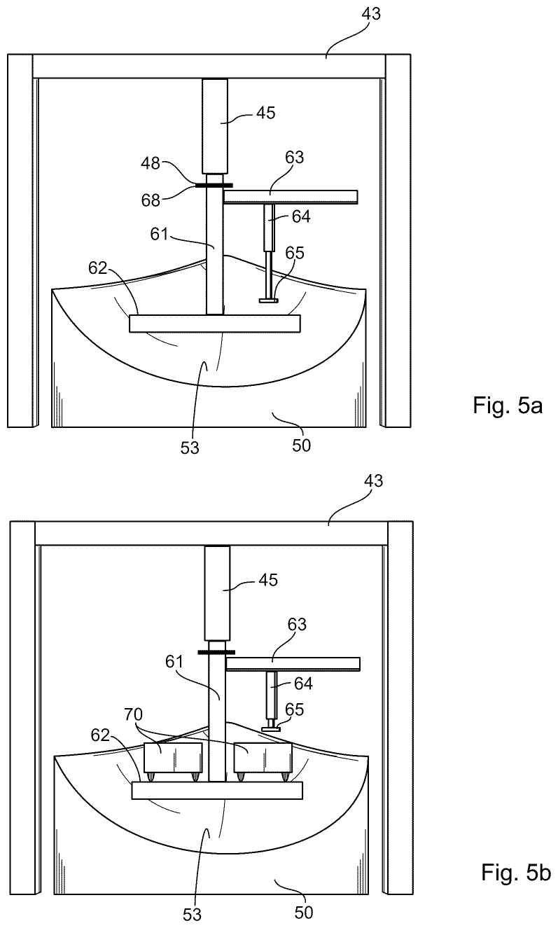

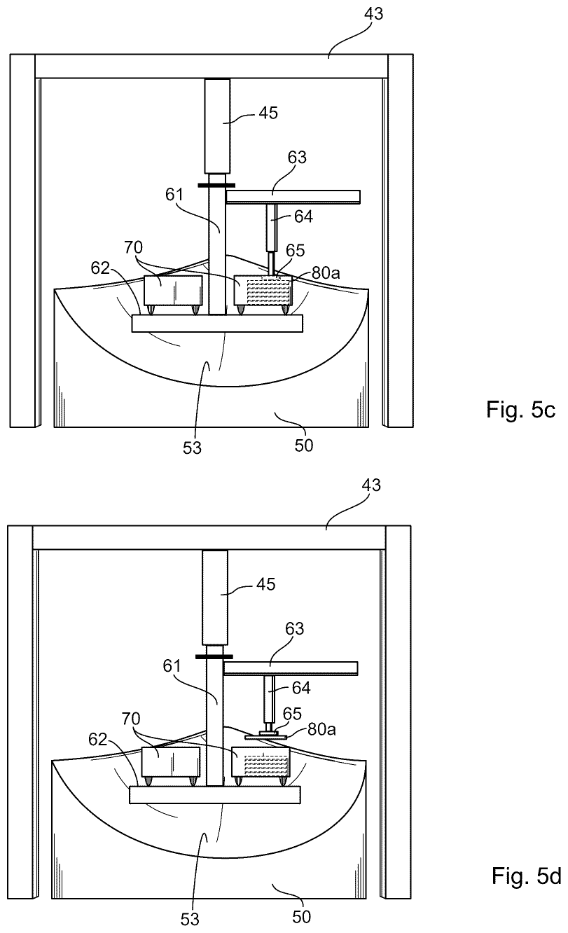

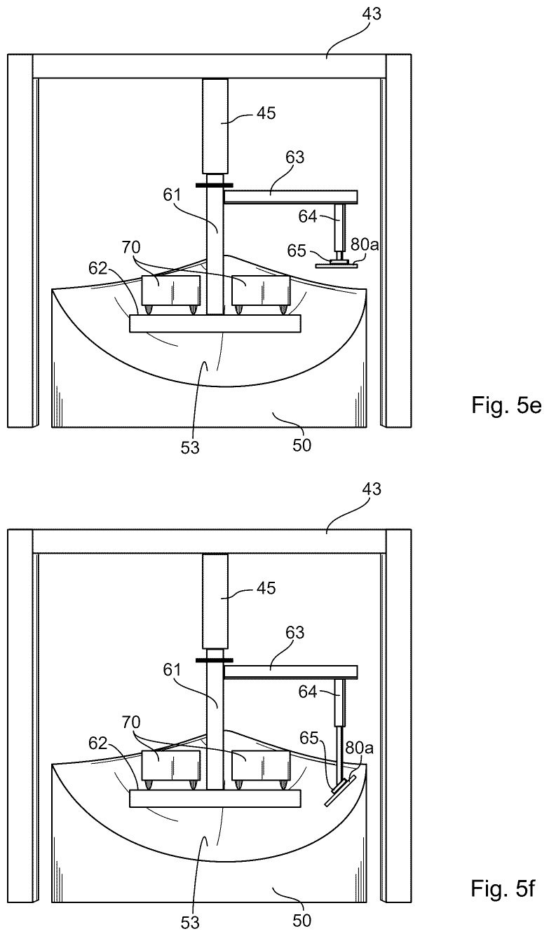

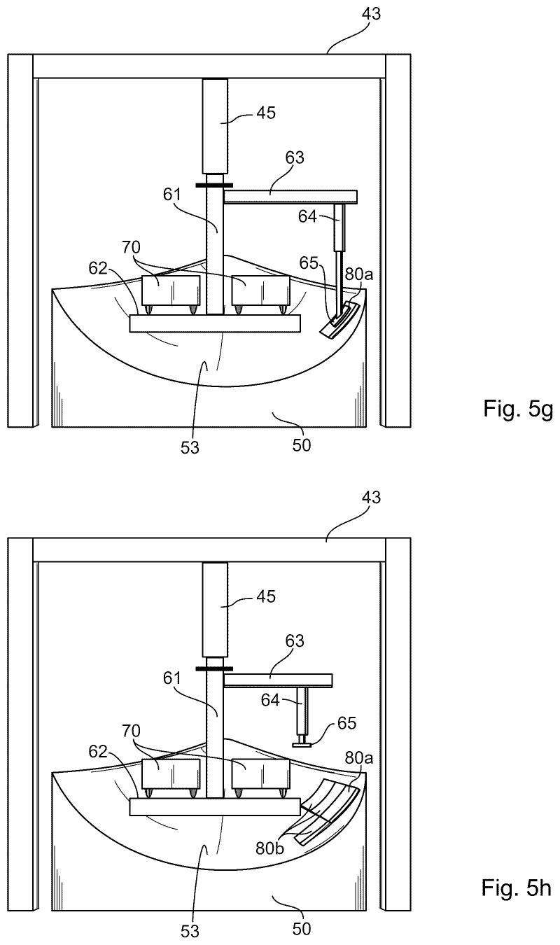

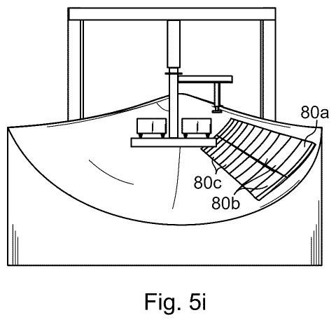

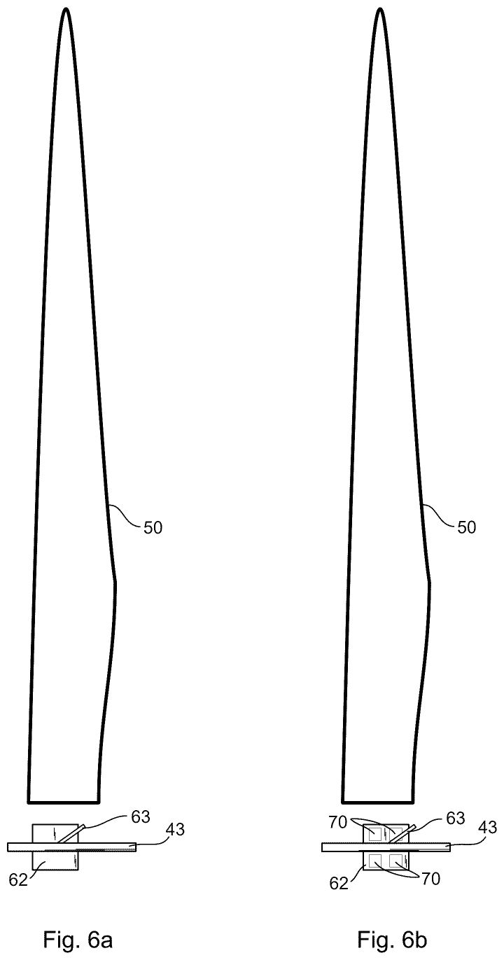

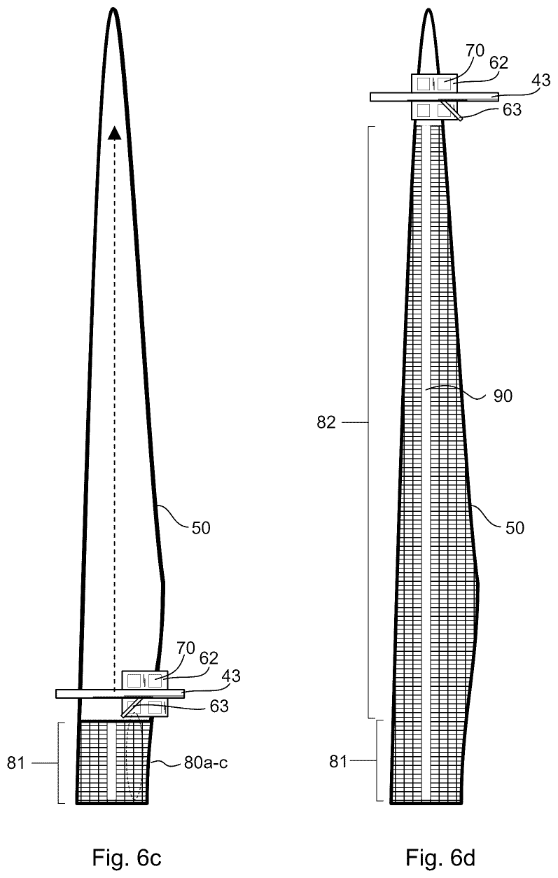

FIG. 5a illustrates a system comprising a gantry 43 with the layup tool 60 operably attached to the gantry 43. The gantry 43 is moveable along a mold 50. The system is operable to perform the methods described in detail below in relation to FIGS. 5b-5i and FIGS. 6a-6d. The methods are described in connection with providing core elements as part of manufacturing a wind turbine blade shell part, such as a suction side or a pressure side of a wind turbine blade.

FIG. 5b illustrates the platform 62 of the layup tool 60 having been loaded with a plurality of elements to be placed in the mold. In this example, the elements are contained in trolleys 70 (wheeled containers). The wheels allow the containers to be rolled onto the platform. The elements may also be placed directly on the platform or be placed on pallets that are then placed on the platform. The number of elements that can be carried in a single run of the layup tool depends on the size of the platform and the size of the elements. An advantage of the invention is that more than one element is available for placement, which avoids having to fetch a new element after each element has been placed (unless a plurality of elements are available, which means that elements need to be placed in the mold. This carries the risks described above, such as the risk of displacing material already placed meticulously in the mold. Having a plurality of elements available therefore increases speed, and storing the elements temporarily on a platform as described above prevents damage to or displacement of material already placed in the mold 50.

In FIG. 5b, the lifting means 64 with the gripper 65 as an end effector is positioned above one of the containers 70. That is, the rotatable arm 63 is turned and the lifting means 64 displaced along the rotatable arm 63 such that the gripper 65 is positioned above the container. Thus, the layup tool is almost entirely configured to pick up an element from the container above which the gripper is positioned in FIG. 5b.

FIG. 5c illustrates the lifting means 64 having been extended vertically to bring the gripper into contact with an element in the container, whereby the gripping can be performed. The gripper 65 and elements to be placed, including a topmost element 80a, are indicated with dashed lines in the container. As shown, the gripper 65 is brought into contact with the topmost element 80a, and a gripping action is performed. If the gripper 65 is a vacuum lifter, the gripping is performed by providing suction in the vacuum lifter, whereby the topmost element 80a is held by the vacuum lifter. By using a vacuum spider with a plurality of flexible suction elements, even curved elements can be held. Typically, at least some of the elements needed for a wind turbine blade shell part are curved to such an extent that a vacuum spider is required in order to be able to hold the element 80a.

FIG. 5d illustrates the lifting means 64 having been lifted (by retraction). The lifting means 64 and the gripper 65 holding the element 80a to be placed can then move along the rotatable arm 63. The layup tool 60 is controlled such as to bring the element 80a to the desired placement position. The layup tool 60 is preferably controllable in three dimensions, which makes the placement of elements easier. Alternatively, the gantry will need to contribute to the displacement to the gripper, which is an unnecessarily complicated solution because the gantry is large compared to the elements to be placed in the mold.

FIG. 5e illustrates the lifting means 64 having been displaced to a position near the end of the rotatable arm 63, which has brought the element 80a to a position near the edge of the mold to be placed there.

FIG. 5f illustrates the lifting means 64 having been extended partway towards the surface 53 of the mold 50 or materials arranged in the mold. The element 80a is very near the desired position. As is seen from the previous figures, the exemplary tool has a substantial reach within a three-dimensional region defined by the rotatable arm 63 and the lifting means 64 (and by the platform 62, which restricts the position for a given position of the support 61). Depending on the weight of elements, some of the motion of the gripper 65 can be made manually. For instance, the gripper 65 could be attached to a pole and the lifting means 64 light enough to be displaced along the rotatable arm 63 by a user. Such a pole could also allow the user to change the pose of the elements to accommodate the curvature of the mold surface 53. An unlimited number of suitable pick-and-place means is available and the choice is a matter of design. For the purpose of achieving high operating speed, some or all of the degrees of freedom are motorized, which reduces the layup time.

FIG. 5f shows the gripper 65 being at a different angle compared to that in FIG. 5e. The change in angle is the result of a manually performed or motorized (such as electrically actuated) rotation in a joint attaching the gripper 65 to the lifting device 64. In other embodiments of the layup tool 60, the rotation is provided in other ways.

The rotation of the gripper 65 brings the element 80a into a posture closer to or identical to the final posture required for placing the element 80a in the correct position in the mold 50.

FIG. 5g illustrates the element 80a having been placed in the desired position in the mold by an additional adjustment of the posture of the gripper 65 combined with an additional vertical motion of the lifting means 64.

It is seen that the steps described above and illustrated in FIGS. 5b-5g allow for a fast, safe, and precise positioning of an element in a mold. In accordance with the invention, the procedure is subsequently repeated for the further elements available in the containers 70 on the platform 62.

FIG. 5h illustrates placement of three additional elements 80b from the current position of the gantry. By displacing the layup tool back and forth on the gantry (left or right in FIG. 5h, see also FIG. 3); by rotating the rotatable arm 63; by displacing the lifting means 64 along the rotatable arm 63; and by providing appropriate vertical motion of the lifting means 64, the three elements 80b can be placed. In this example, further elements can be placed from the current position of the gantry along the mold 50.

FIG. 51 illustrates placement of additional elements 80c along the longitudinal axis of the mold 50 (corresponding to the longitudinal axis of the blade, shown in FIG. 2). To place the additional elements 80c, the gantry 43 has been moved along the mold 50 by an appropriate amount. In this example, this is needed because the reach of the rotatable arm 63 and the lifting means 64 is insufficient to place the additional elements 80c further down the mold 50.

In accordance with the invention, the platform (or one or more containers or pallets on the platform) initially comprises a plurality of elements. At some point, the containers may run out of elements. In that case, the gantry can be moved to a loading position where the containers are replenished with further elements to be placed in the mold. As described above, carrying a plurality of elements on the platform reduces the number of times needed to fetch elements and thereby reduces the amount of time needed to place the elements from start to finish. Furthermore, as described above, embodiments of the invention eliminate the need for personnel to stand on material already laid up in the mold and accidentally displacing some of the material. This is most easily achieved by a layup tool and gantry that are automatically controlled and operate according to a program defining the position of the individual elements in the mold. Alternatively, personnel may have wired or wireless control of the system allowing them to perform the placement of the individual elements. The system may be more or less automated, as also described above. For instance, in some embodiments, the user operates a joystick in a direction representing the desired motion of the gripper, and the system effects the desired motion by controlling the different degrees of freedom as required. In the present example, the degrees of freedom include the position of the gantry 43 along the mold 50, the position of the layup tool 60 on the gantry 43 (from side to side), the angle of the rotatable arm 63 on the support 61, the vertical displacement of the lifting means 64, and the angle of the gripper 65 on the lifting device 64.

FIGS. 6a-6d illustrate a similar process in a top view of the mold.

FIG. 6a illustrates the mold 50 without elements. Elements such as core elements for a wind turbine blade shell part are to be placed on fibre-reinforcement material placed in a mold. Such material is not shown explicitly in FIGS. 6a-6d.

The gantry 43 with the layup tool 60 attached to it is in a position near the root end of the mold. The gantry 43 may previously have been equipped with tools for adding wind turbine blade material, such as fibre-reinforcement material, in the mold 50. These tools have been detached from the gantry robot arm mount (illustrated in FIG. 3) and replaced by the layup tool 60 shown in FIG. 4. FIG. 6a shows the platform 62 and the rotatable arm 63 and the gantry 43 ready for being used to place elements in the mold 50.

FIG. 6b illustrates the platform 62 of the layup tool 60 having been loaded with containers 70 (or pallets or similar means) holding elements to be placed in the mold 50 as described above and illustrated in FIGS. 5b-5i. In the present example, there are four containers 70 on the platform 62. This is a matter of design. For long blades, it may be advantageous to provide a large platform 62 that can hold a relatively large number of elements corresponding to an area of a certain size in the mold 50. It may also be advantageous to be able to load the platform at the tip end in addition to the root end. This reduces gantry 43 travel time when additional elements are needed when operating nearer to the tip end than to the root end.

FIG. 6 c illustrates part of the process of placing the elements having been performed. A number of elements 81 have been laid up using a system in accordance with the invention, rather than personnel having walked in the mold and performed the placement of elements.

Since, as FIG. 6c indicates, a large number of elements is typically needed, the system also reduces the time needed for the placement of elements by a significant amount. The sheer size of the blade also provides ample opportunity for personnel to inadvertently displace material in the mold, a problem that the invention mitigates.

An area corresponding to the elements 80a-80c shown in FIG. 5i is indicated in the lower right part of FIG. 6c. Note that FIGS. 5a-5i and FIGS. 6a-6d illustrate processes in accordance with the invention, but FIGS. 5a-5i and FIGS. 6a-6d shall not be construed as illustrating the exact same process. Each set of figures illustrates different aspects of processes in accordance with the invention.

As indicated by the dashed arrow in FIG. 6c, the gantry 43 with the layup tool 60 moves along the mold 50, and additional elements are placed in the mold using the pick-and-place means.

FIG. 6d illustrates the completed layup of elements in the mold 50 after placement of additional elements 82, whereby the process of placing all the required elements 81, 82 in the mold 50 is complete. The gantry 43 and layup tool 60 are shown in a position near the tip end of the mold 50 in which the last elements have been placed. The tip end of a blade is typically free of core elements, as also illustrated in FIG. 6d. In this example, a spar cap 90 extends along the longitudinal axis of the blade. Alternatively, the reference 90 may be space left behind to accommodate a spar cap after the elements 81, 82 have been placed in the mold.

After having placed all the elements, the gantry 43 with the layup tool can be returned to the root end of the mold 50, corresponding to the position shown in FIGS. 6a and 6b. This allows the layup tool 60 to be detached and replaced by another deposition tool. Any additional blade 16 material can be placed, and resin can be supplied to form a composite wind turbine blade shell part. This may be done using a deposition tool or manually.

During the process of placing elements in the mold 50, it will typically be necessary to return the system to the root end in order to resupply elements, since the platform 62 is typically relatively small compared to the mold 50. A small platform 62 makes the layup tool 62 smaller and lighter. Furthermore, a bigger platform also requires that the layup tool have a longer reach. Thus, a relatively small platform 62 may be used at the expense that more trips to replenish elements on the platform 62 are needed. However, this is an acceptable compromise since the advantages of the invention outweigh the need to move the gantry 43 for instance to the root to replenish the platform 62 with additional elements and returning the gantry to the position where new elements are to be placed.

Various embodiments of the invention are set out in the following items:
1. A system for laying up a first plurality of pre-manufactured elements (80 a-80c, 81, 82) in a mold (50) for a fibre-reinforced wind turbine blade part, such as a wind turbine blade shell part, the system comprising:
a mold (50) for forming the fibre-reinforced wind turbine blade part,
a platform (62) for carrying the first plurality of elements, the platform being moveable above and along at least a part of the mold, the platform being moveable to a loading position at which the first plurality of elements can be loaded to the platform,
pick-and-place means (63, 64, 65) for picking up each of the elements of the first plurality of elements when carried on the platform and while the platform is located above the mold, and placing the elements at corresponding positions in the mold.
2. A system in accordance with item 1, further comprising a gantry (43) moveable along at least a part of the mold, the platform and the pick-and-place means being attached to or attachable to the gantry.
3. A system in accordance with item 2, wherein the pick-and-place means and the platform form parts of a layup tool attachable to and detachable from the gantry.

4. A system in accordance with any of the preceding items, wherein the pick-and-place means is adapted to pick up and place core elements for a wind turbine blade shell in the mold, such as core panels for a wind turbine blade shell.
5. A system in accordance with any of the preceding items, wherein the pick-and-place means for picking up and placing the first plurality of elements in the mold comprises a robot controllable by a robot controller, the robot comprising a gripper end effector (65) for picking up each of the elements of the plurality of elements.
6. A system in accordance with any of the preceding items, wherein the system further comprises:
means for identifying a first element of the first plurality of elements and a second element of the first plurality of elements, the second element being distinguishable from the first element,
a digital controller configured to control the pick-and-place means to perform the steps of:
   i. picking up the first element from the platform, identifying the first element, and placing the first element at a first location associated with the first element; and
   ii. picking up the second element from the platform, identifying the second element, and placing the second element at a second predetermined location associated with the second element, wherein the second location is different from the first predetermined location.
7. A system in accordance with item 6, wherein identifying the first element and the second element comprises identifying the first element and the second element based on one or more of: a shape of the elements; a dimension of the elements; a colour of the elements; a weight of the elements; an electronic tag on or in the elements.
8. A system in accordance with item 6, wherein the means for identifying the first element and the second element comprises imaging means for recording an image of the first element and an image of the second element, and wherein the digital controller is configured to identify the first element and the second element based on one or more of: letters and/or number on the elements; barcodes on the elements.
9. A system in accordance with any of the preceding items, wherein the pick-and-place means uses vacuum means to pick up each of the elements of the first plurality of elements.
10. A system in accordance with any of the preceding items, wherein the pick-and-place means comprises a vacuum lifter with one or more suction elements for contacting and holding each of the elements of the first plurality of elements.
11. A system in accordance with item 9 or 10, wherein the pick-and-place means comprises a vacuum spider for picking up each of the plurality of elements from the platform.
12. A system in accordance with any of the preceding items, wherein the loading position of the platform is located in a vicinity of a root end of the mold, such as in a position in which the platform is not positioned above the mold.
13. A system in accordance with any of the preceding items, wherein the platform is vertically displaceable at least at the loading position, optionally to a height at which the platform rests on the ground.
14. A method for laying up a first plurality of pre-manufactured elements (80 a-80c, 81, 82) in a mold (50) for a fibre-reinforced wind turbine blade part, such as a wind turbine blade shell part, the method comprising:
placing the first plurality of elements on a platform at a loading position, the platform being moveable above and along at least a part of the mold,
moving the platform to a first platform position along the mold and picking up, using pick-and-place means, a first element of the first plurality of elements and placing the first element at a first element position in the mold,
picking up, using the pick-and-place means, a second element of the first plurality of elements and placing the second element at a second element position different from the first element position.
15. A method in accordance with item 14, wherein the pick-and-place means comprises a robot with a gripper end effector for performing the steps of picking up and placing the first element and the second element in the mold, and wherein the pick-and-place means and the platform are parts of a layup tool that is releasably attached to a gantry moveable along the mold.
16. A method in accordance with item 14 or 15, wherein the first element and the second element are picked up and placed without loading one or more additional elements onto the platform after picking up and placing the first element and before picking up and placing the second element.
17. A method in accordance with any of items 14-16, further comprising:
placing a second plurality of elements in the mold, wherein the second plurality of elements are elements other than core elements.
forming a mold cavity by placing a vacuum bag over the mold, the mold cavity comprising at least the first plurality of elements,
infusing resin into the mold cavity and curing the resin.
18. A method in accordance with item 17, the method further comprising:
moving the platform to the first platform position or to a second platform position along the mold,
picking up, using the pick-and-place means, a first element of the second plurality of elements and placing the first element of the second plurality of elements at a third element position in the mold,
picking up, using the pick-and-place means, a second element of the second plurality of elements and placing the second element of the second plurality of elements at a fourth element position different from the third element position.
19. A method in accordance with any of items 14-18, wherein the first plurality of elements is a first plurality of core elements, such as a first plurality of core panels, for forming one or more core portions of a wind turbine blade part.
20. A method in accordance with any of items 14-19, wherein the pick-and-place means uses vacuum means to pick up each of the elements of the first plurality of elements.
21. A method in accordance with any of items 14-20, wherein the pick-and-place means comprises a vacuum lifter with one or more suction elements for picking up each of the elements of the first plurality of elements.
22. A method in accordance with any of items 14-21, wherein the pick-and-place means comprises a vacuum spider for picking up each of the plurality of elements from the platform.
23. A layup tool (60) for laying up a plurality of pre-manufactured elements (80 a-c, 81, 82), the layup tool (60) being attachable to a gantry (43) configured to travel along a mold (50) for forming a wind turbine blade shell part, the layup tool comprising:
a platform,
pick-and-place means for picking up each of the elements of the first plurality of elements, when carried on the platform and while the platform is located above the mold, and placing the elements at corresponding positions in the mold.
24. A layup tool in accordance with item 23, wherein the layup tool comprises a robot and a robot controller for controlling the robot, the robot comprising a gripper end effector (65) for picking up each of the elements of the plurality of elements from the platform and placing the element in a corresponding position in the mold.

### LIST OF REFERENCES

2 wind turbine
4 tower
6 nacelle
8 hub
10 blade
11,12 blade shell part
14 blade tip
15 tip end
16 blade root
18 leading edge of blade
20 trailing edge of blade
30 root region
31 root end
32 transition region
34 airfoil region
36 pressure side shell part
38 suction side shell part
40 blade shoulder
43 gantry
45 gantry robot arm
48 gantry robot arm mount
50 blade mold for wind turbine blade shell part
53 blade mold surface, fibre-reinforcement material on blade mold surface
60 layup tool
61 layup tool support
62 layup tool platform
63 rotatable arm
64 lifting means
65 gripper
68 layup tool mount
70 element containers
80a-c elements, e.g. core elements for wind turbine blades
81 elements
82 elements
90 spar cap/space for spar cap
L_{B} Longitudinal axis, longitudinal extent

1. A system for laying up a first plurality of pre-manufactured elements (80a-80c, 81, 82) in a mold (50) for a fibre-reinforced wind turbine blade part, such as a wind turbine blade shell part, the system comprising:
a mold (50) for forming the fibre-reinforced wind turbine blade part,
a platform (62) for carrying the first plurality of elements, the platform being moveable above and along at least a part of the mold, the platform being moveable to a loading position at which the first plurality of elements can be loaded to the platform,
pick-and-place means (63, 64, 65) for picking up each of the elements of the first plurality of elements when carried on the platform and while the platform is located above the mold, and placing the elements at corresponding positions in the mold.

2. A system in accordance with claim 1, further comprising a gantry (43) moveable along at least a part of the mold, the platform and the pick-and-place means being attached to or attachable to the gantry.

3. A system in accordance with claim 2, wherein the pick-and-place means and the platform form parts of a layup tool attachable to and detachable from the gantry.

4. A system in accordance with claim 1, wherein the pick-and-place means is adapted to pick up and place core elements for a wind turbine blade shell in the mold, such as core panels for a wind turbine blade shell.

5. A system in accordance with claim 1, wherein the pick-and-place means for picking up and placing the first plurality of elements in the mold comprises a robot controllable by a robot controller, the robot comprising a gripper end effector (65) for picking up each of the elements of the plurality of elements.

6. A system in accordance with claim 1, wherein the system further comprises:
means for identifying a first element of the first plurality of elements and a second element of the first plurality of elements, the second element being distinguishable from the first element,
a digital controller configured to control the pick-and-place means to perform the steps of:
i. picking up the first element from the platform, identifying the first element, and placing the first element at a first location associated with the first element; and
ii. picking up the second element from the platform, identifying the second element, and placing the second element at a second predetermined location associated with the second element, wherein the second location is different from the first predetermined location.

7. A system in accordance with claim 6, wherein identifying the first element and the second element comprises identifying the first element and the second element based on one or more of: a shape of the elements; a dimension of the elements; a colour of the elements; a weight of the elements; an electronic tag on or in the elements.

8. A system in accordance with claim 6, wherein the means for identifying the first element and the second element comprises imaging means for recording an image of the first element and an image of the second element, and wherein the digital controller is configured to identify the first element and the second element based on one or more of: letters and/or number on the elements; barcodes on the elements.

9. A system in accordance with claim 1, wherein the pick-and-place means uses vacuum means to pick up each of the elements of the first plurality of elements, wherein the pick-and-place means comprises a vacuum lifter with one or more suction elements for contacting and holding each of the elements of the first plurality of elements, the pick-and-place means comprising a vacuum spider for picking up each of the plurality of elements from the platform.

10. A system in accordance with claim 1, wherein the loading position of the platform is located in a vicinity of a root end of the mold, such as in a position in which the platform is not positioned above the mold, wherein the platform is vertically displaceable at least at the loading position, optionally to a height at which the platform rests on the ground.

11. A method for laying up a first plurality of pre-manufactured elements (80a-80c, 81, 82) in a mold (50) for a fibre-reinforced wind turbine blade part, such as a wind turbine blade shell part, the method comprising:
placing the first plurality of elements on a platform at a loading position, the platform being moveable above and along at least a part of the mold,
moving the platform to a first platform position along the mold and picking up, using pick-and-place means, a first element of the first plurality of elements and placing the first element at a first element position in the mold,
picking up, using the pick-and-place means, a second element of the first plurality of elements and placing the second element at a second element position different from the first element position.

12. A method in accordance with claim 11, wherein the pick-and-place means comprises a robot with a gripper end effector for performing the steps of picking up and placing the first element and the second element in the mold, and wherein the pick-and-place means and the platform are parts of a layup tool that is releasably attached to a gantry moveable along the mold.

13. A method in accordance with claim 11, wherein the first element and the second element are picked up and placed without loading one or more additional elements onto the platform after picking up and placing the first element and before picking up and placing the second element.

14. A method in accordance with claim 11, further comprising:
placing a second plurality of elements in the mold, wherein the second plurality of elements are elements other than core elements.
forming a mold cavity by placing a vacuum bag over the mold, the mold cavity comprising at least the first plurality of elements,
infusing resin into the mold cavity and curing the resin.

15. A method in accordance with claim 14, the method further comprising:
moving the platform to the first platform position or to a second platform position along the mold,
picking up, using the pick-and-place means, a first element of the second plurality of elements and placing the first element of the second plurality of elements at a third element position in the mold,
picking up, using the pick-and-place means, a second element of the second plurality of elements and placing the second element of the second plurality of elements at a fourth element position different from the third element position.

16. A method in accordance with claim 11, wherein the first plurality of elements is a first plurality of core elements, such as a first plurality of core panels, for forming one or more core portions of a wind turbine blade part, wherein the pick-and-place means comprises a vacuum lifter with one or more suction elements for contacting and holding each of the elements of the first plurality of elements, the pick-and-place means comprising a vacuum spider for picking up each of the plurality of elements from the platform.

17. A layup tool (60) for laying up a plurality of pre-manufactured elements (80a-c, 81, 82), the layup tool (60) being attachable to a gantry (43) configured to travel along a mold (50) for forming a wind turbine blade shell part, the layup tool comprising:
a platform,
pick-and-place means for picking up each of the elements of the first plurality of elements, when carried on the platform and while the platform is located above the mold, and placing the elements at corresponding positions in the mold.

18. A layup tool in accordance with claim 17, wherein the layup tool comprises a robot and a robot controller for controlling the robot, the robot comprising a gripper end effector (65) for picking up each of the elements of the plurality of elements from the platform and placing the element in a corresponding position in the mold.
